(19) United States
(12) Patent Application Publication
(10) Pub. No.: US 2007/0111580 A1
(43) Pub. Date: May 17, 2007

(54) Contact for CPU socket

(75) Inventors: Li-Bang Chen, Tu-Cheng (TW); Hung-Yang Yeh, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/599,748

(22) Filed: Nov. 14, 2006

(30) Foreign Application Priority Data
Nov. 14, 2005 (TW) 94139848

(51) Int. Cl. H01R 4/50

(52) U.S. Cl. 439/342

(57) ABSTRACT

An electrical connector for electrically connecting a CPU with a plurality of conductive pads and a PCB comprises an insulative housing and a number of terminals received in the housing. Each terminal includes a base, an elastic arm extending from the base and a solder section connected with the PCB. A contact section near the elastic arm protrudes a contact portion to meet the pads of the CPU and to increase the contact friction and remove the oxidation layer and any contaminant of the pads.

### BACKGROUND OF THE INVENTION

1. Field of the Invention

The present invention relates to the art of electrical connectors, and particularly to an electrical connector for electrically connecting a CPU (Central Processing Unit) and a PCB (printed circuit board).

2. Description of the Prior Art

Electrical connectors are provided in a wide field to electrically connect two electronic components, such as a CPU package and a PCB.

An electrical connector for electrically connecting the CPU and the PCB comprises a housing and a plurality of terminals received in said housing. The housing includes a first surface for engaging with the CPU, a second surface opposite to the PCB and a number of terminal-receiving passageways running through the first and second surfaces. Each terminal comprises a base, a contact section and a soldering section extending from the base to outwardly of the first and second surfaces, respectively. When the soldering section of the terminal is attached to the corresponding soldering point of the PCB, the contact section comes to flexibly deform and slide over the pads of the CPU in the action of the CPU pressing the contact section to electrically connect.

In use, as the CPU is often exposed to the surroundings of atmosphere, a layer of oxidation and other feculence of the pads are easy to form on the surface of the pads. At the same time, the contact section of the terminal is attached to the pads of the CPU in the width direction of the whole contact section such that contact friction is poor and the ability of removing the feculence is deficient.

Thus, there is a need to provide an electrical connector for electrically connecting the CPU and the PCB to overcome the above-mentioned problems.

### SUMMARY OF THE INVENTION

Accordingly, an object of the present invention is to provide an electrical connector to improve the capability of transmission between the CPU and the PCB.

To fulfill the above-mentioned object, an electrical connector for electrically connecting the CPU with a plurality of conductive pads and the PCB in accordance with a preferred embodiment of the present invention comprises an insulative housing and a plurality of terminals received in said housing. The housing includes a first surface for engaging with the CPU, a second surface opposite to the PCB, and a plurality of terminal-receiving passageways running through the first and second surface. Each terminal comprises a base extending along each passageway, an elastic arm extending from the base towards the CPU, and a soldering section integrally attached to the PCB. A contact section is located near the end of the elastic arm of the terminal and a contact portion protrudes from a middle of the contact section to engage the pads of the CPU.

That the middle of the contact section defines a contact portion and the terminal is attached to the pads of the CPU only by said contact portion can reduce the contact area between terminals and conductive pads and thus increase the feculence removal efficiency.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, perspective view of an electrical connector in accordance with a preferred embodiment of the present invention;

FIG. 2 is an exploded, isometric view of a terminal of the electrical connector;

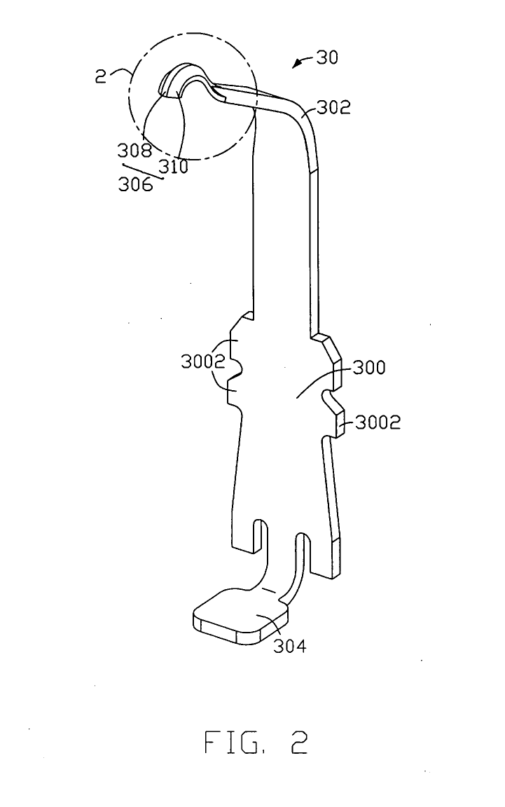

FIG. 3 is an enlarged view of a circled part 2 in FIG. 2;

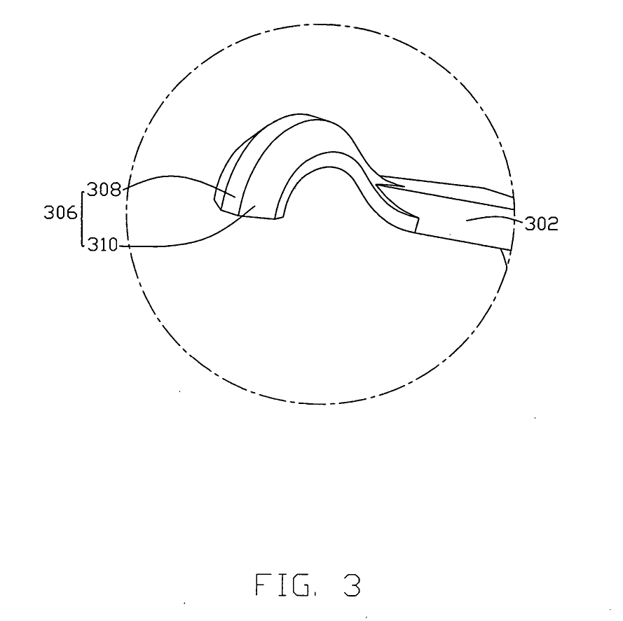

FIG. 4 is a cross-sectional view taken along line 1-1 in FIG. 1, with the contact section of the terminals unconnected to the pads of the CPU;

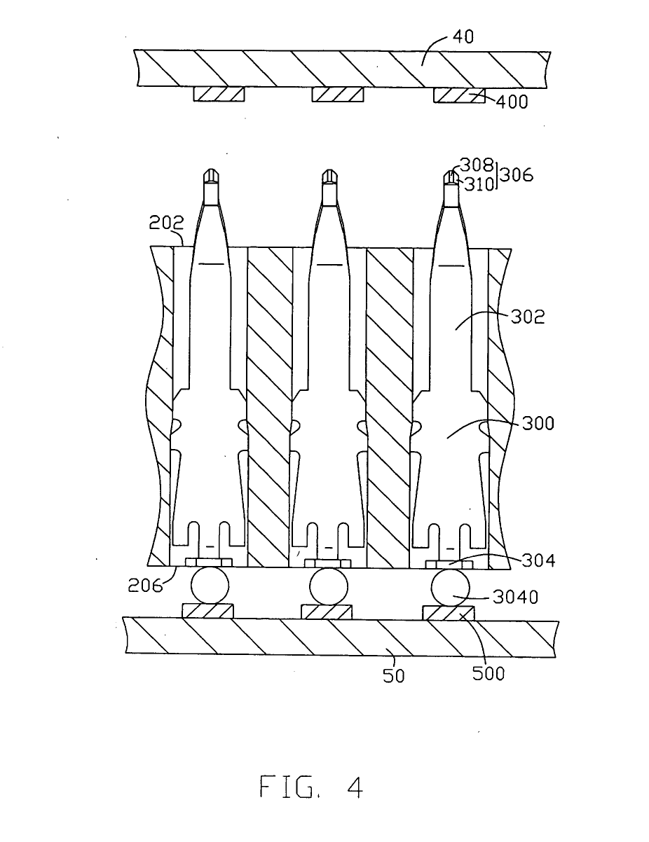

FIG. 5 is similar to FIG. 4, but the contact section of the terminal has been connected to the pad of the CPU completely.

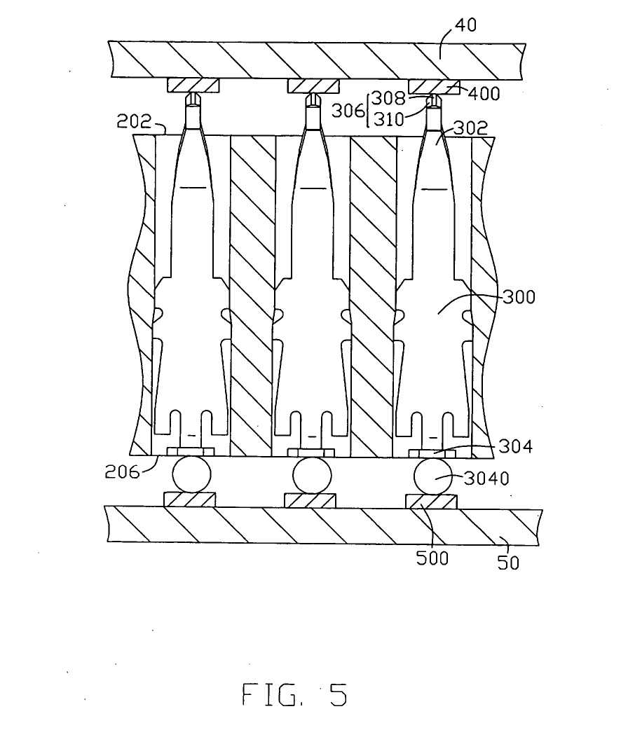

### DESCRIPTION OF PREFERRED EMBODIMENT OF THE INVENTION

Reference will now be made to the drawings to describe the present invention in detail.

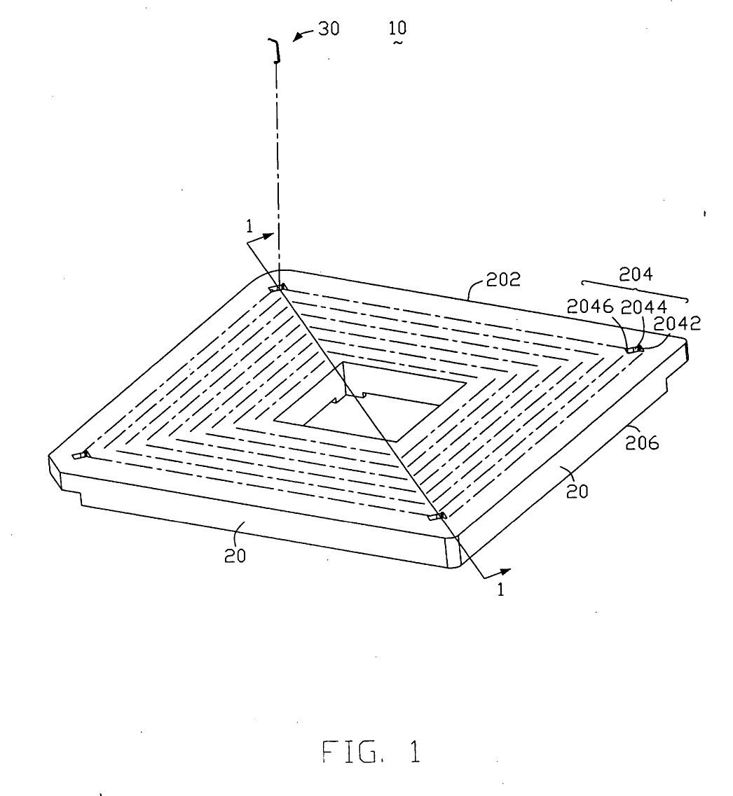

FIG. 1 is an exploded, isometric view of an electrical connector 10 for electrically connecting the CPU 40 and the PCB 50 in accordance with the preferred embodiment of the present invention. The electrical connector 10 comprises an insulative housing 20 and a plurality of terminals 30 received in said housing 20.

The housing 20 comprises a first surface 202 for engaging with the CPU 40, a second surface 206 opposite to the PCB 50, and a plurality of terminal-receiving passageways 204 aligned as a matrix and extending through the first and second surfaces 202, 204. Each passageway 204 includes a first elongate cavity 2042 and a second cavity 2046 vertical to the first cavity 2042. A slant 2044 connects the first and second surfaces 2042, 2046.

Each terminal 30 includes a flatten base 300 with a number of barbs 3002 in the two opposite lateral side thereof for interferential engagement with the first cavity 2042 of the passageway 204, a soldering section 304 extending from a bottom edge of the base 300, and an elastic arm 302 extending curvedly from a top edge of the base 300. The elastic arm 302 has a contact section 306 near the free end thereof. And a contact portion 308 protrudes from the middle of the contact section 306 by punching a respective chamfer 310 on either side thereof so as to meet the pads 400 of the CPU 40. The contact section 306 connects to the pads 400 of the CPU 40 only by the contact portion 308 in order to reduce the contact area between the terminal 30 and the pad 400 when terminals 30 are attached to the pads 400.

During mounting the terminals 30 onto the housing 20, the terminals 30 are assembled with corresponding passageways 204 from below. The base 300 is retained in the first cavity 2042 and engaged interferentially with the sidewalls thereof by the barbs 3002. And the elastic arm 302 extends from the slant 2044 to outwardly of the second cavity 2046. After assembling, the contact section 306 of the terminal 30 extends outwardly of the first surface 202 of the housing 20 and the soldering section 304 extends outwardly of the second surface 206.

In the mounting process, the soldering section 304 of the terminal 30 is connected to the soldering point 500 of the PCB 50 by a solder ball 3040 and the contact portion 308 of the elastic arm 302 extends outwardly of the first surface 202. At the beginning of assembling the CPU 40 on the electrical connector 10, the conductive pads 400 of the CPU 40 is placed on the contact section 306 of the terminal 30. With CPU 40 pressing the housing 20 by the action of an external force, the conductive pad 400 of the CPU 40 presses the contact section 306 till the elastic arm 302 of the terminal 30 becomes deformed. The terminal 30 does not slide immediately relative to the pad 400 of the CPU 40 and remove the oxidation layer and the feculence of the pad 400 until the force of pressing overcomes the frictional force between the contact portion 308 and the conductive pad 400 thereof in order to provide a better electrical connection.

In the course of connection between the terminals 30 and the conductive pads 400, the contact area between the terminal 30 and the pad 400 is reduced and the friction therebetween is increased and the oxidation layer and the feculence of the pads 400 is removed so that the contact portion 308 of the terminal 30 mutually connects with the pads 400 of the CPU 40 and the other portion of the contact section 306 is unconnected therewith. At the same time it can insure there is a reliable electrical connection between the CPU 40 and the terminal 30.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electrical connector comprising:
an insulative housing having a plurality of terminal-receiving passageways; and
a plurality of terminals received in said passageways, each terminal including a base extending along the passageway, an elastic arm extending from the base, and a contact section near the end of said elastic arm; wherein
a contact portion protrudes from a middle of the contact section.

2. The electrical connector as claimed in claim 1, wherein the two opposite lateral sides of the terminal are oblique.

3. The electrical connector as claimed in claim 1, wherein the passageway comprises an elongate first cavity retaining the base of the terminal and a second cavity vertical to the first cavity and accommodating the elastic arm of the terminal, the elastic arm extending from the first cavity to partly outwardly of the housing.

4. The electrical connector as claimed in claim 3, wherein the two lateral sides of the base of the terminal define a plurality of barbs for interferential engagement with the first cavity of the housing.

5. The electrical connector as claimed in claim 4, wherein the elastic arm of the terminal is arcuate, and the contact portion is curved smoothly.

6. The electrical connector as claimed in claim 1, wherein the contact section comprises two chamfers on opposite sides of the contact portion.

7. An electrical connector comprising:
an insulative housing having a plurality of terminal-receiving passageways; and
a plurality of terminals received in said passageways, each terminal including a base extending along the passageway, an elastic arm extending from the base, and a contact section near the end of said elastic arm; wherein
the contact section defines a first upwardly bulged configuration of a cross-section in a lengthwise direction along which the contact section extends from the end of the elastic arm, and a second upwardly bulged configuration of another cross-section in a lateral direction transverse to said lengthwise direction; wherein
each of the first configuration and the second configuration has a highest point on a middle region under the first upwardly bulged configuration is smoothly curved while the second upwardly bulged configuration is deflected by two chamfers on two sides thereof.
